(19) United States
(12) Patent Application Publication
(10) Pub. No.: US 2004/0136637 A1
(43) Pub. Date: Jul. 15, 2004

(54) Sensor,display device and recording device

(76) Inventor: Franciscus Gerardus Coenradus Verweg, Heerlen (NL)

Correspondence Address: Corporate Patent Counsel, Philips Electronics North America Corporation, P O Box 3001, Briarcliff Manor, NY, 10510, US

(21) Appl. No.: 10/478,074

(22) PCT Filed: May 21, 2002
(86) PCT No.: PCT/IB02/01859

(30) Foreign Application Priority Data
May 23, 2001 (EP) 01201975.8

(51) Int. Cl. G02B 6/00

(52) U.S. Cl. 385/12; 385/16

(57) ABSTRACT

Keyboard comprising e.g. LEDs (12) to generate light beams within a transparent synthetic material substrate with cavities to receive keys (2) having a reflective part, if necessary. The fluctuation of light intensity in different directions is detected by means of e.g. photodiodes (18).

The invention relates to a sensor comprising a first optical waveguide of an optically transparent material. The invention particularly relates to a keyboard for use in a (portable) display device. Such display devices find an increasingly wider application in, for example, mobile telephones. However, the invention may also be used in other display devices such as organizers, laptop computers and the like. Due to the increasing miniaturization, the demand for integration of the display screen with the keyboard, but also, for example, with the memory function is increasing.

It is an object of the invention to solve this problem by means of a method in which integration of said components, or at least parts thereof, is realized as much as possible and, to this end, provides a device comprising a light source along a part of the edge of the optical waveguide, and a photosensitive element, while, during operation, keys interrupt the light path of the light from the light source. More generally, the optical waveguide comprises a substrate or a partial substrate of an optically transparent material, with sides transverse to a first surface, at least one of which has an entrance face for light, while light from a light source can be coupled in on said side, and an exit portion for light in a plane transverse to the first surface.

The invention is based on the recognition that light can be guided along the locations of the keys in a transparent substrate, in which at least a part of the light is reflected when a key is depressed. The variation of exiting light is detected by means of the photosensitive element, for example, a photodiode. This photosensitive element (and also the light source) is situated, for example, along a further part of the edge of the optical waveguide, or within or along a further part of the substrate or the partial substrate. This photosensitive element (and also the light source) may in their turn be formed by means of a further optical waveguide and, for example, a photodiode (or a LED).

Said optical waveguide may form part of a larger assembly, for example, a substrate in which also further operating elements for the relevant apparatus (for example, a microphone) have been realized. For example, a second optical waveguide may be realized at another location in the substrate, which second optical waveguide operates as a waveguide for a light source (backlight or front light) of, for example, a liquid crystal display device.

The sensor may of course also be integrated in other apparatus.

These and other aspects of the invention are apparent from and will be elucidated with reference to the embodiments described hereinafter.

In the drawings:

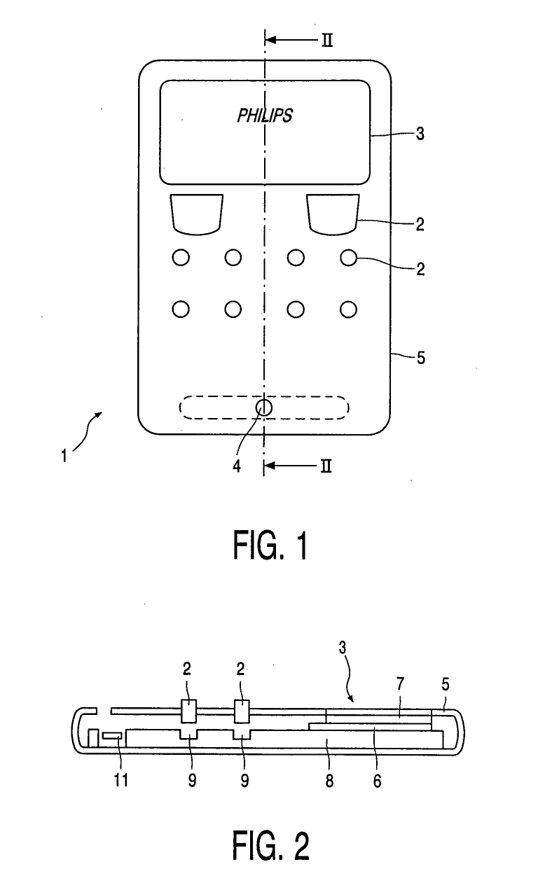

FIG. 1 is a plan view of a mobile phone comprising a sensor according to the invention,

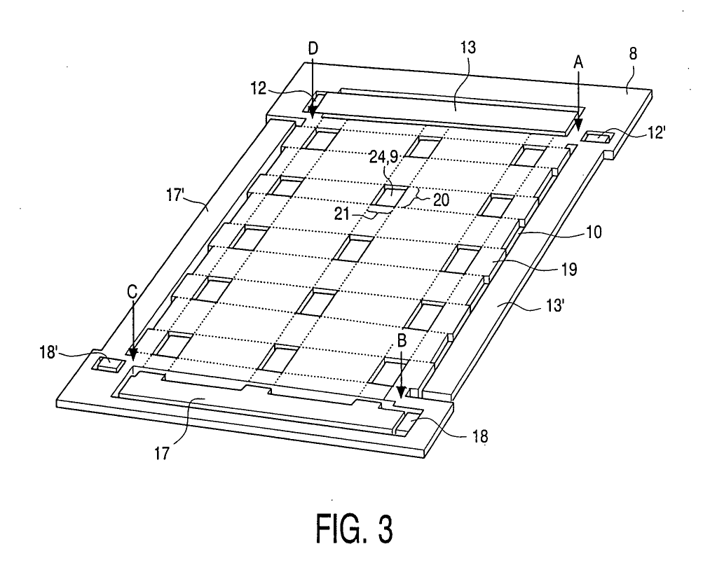

FIG. 2 is a cross-section taken on the line II-II in FIG. 1, while FIG. 3 is a plan view of a part of a substrate in which the sensor has been realized, and

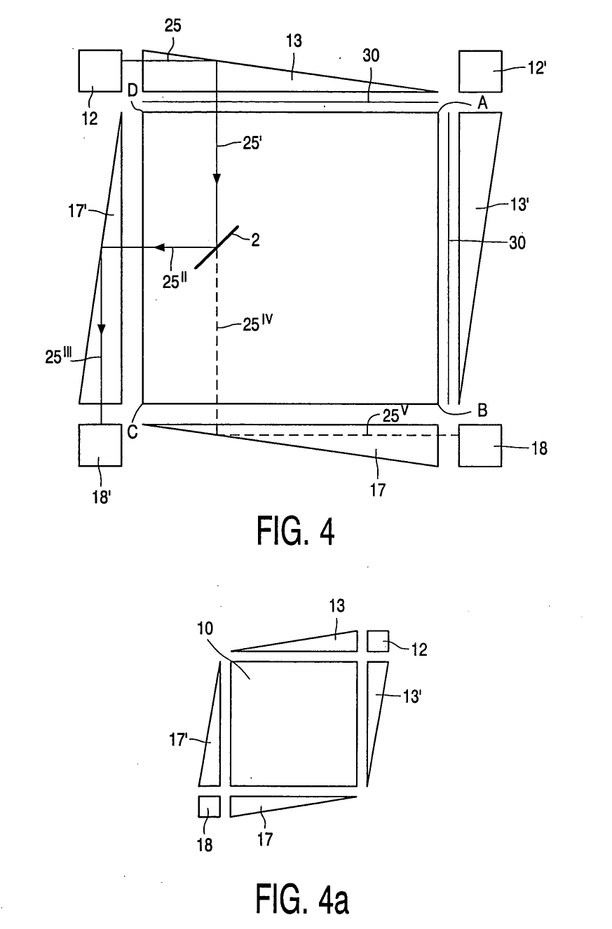

FIG. 4 shows a part of another realization of a part of the sensor, and

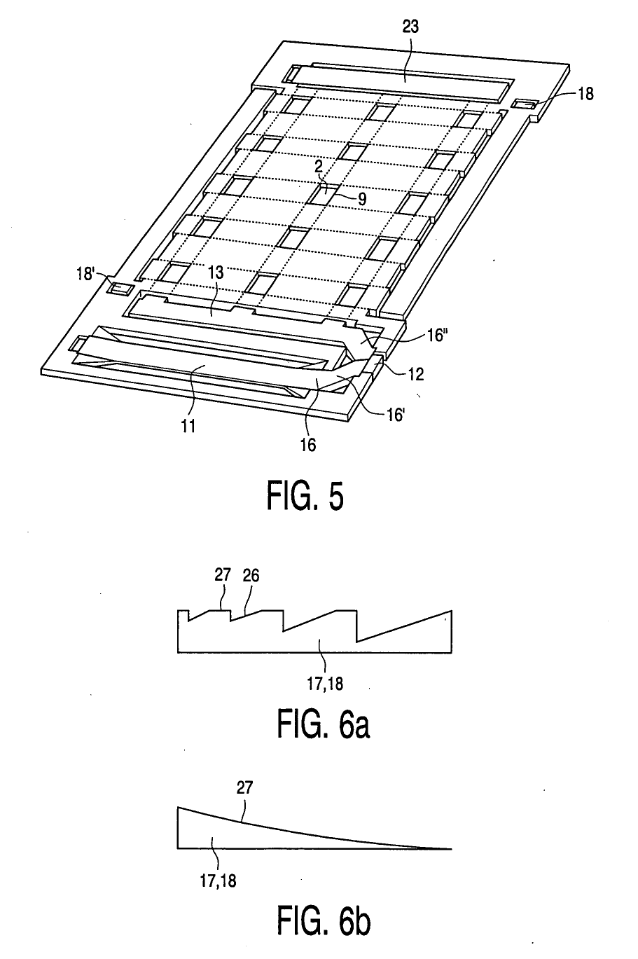

FIGS. 5 and 6 are variants of parts of the sensor.

The drawings are diagrammatic and not drawn to scale. Corresponding components are generally denoted by the same reference numerals.

FIGS. 1 and 2 show a device 1 according to the invention, in this case a mobile phone comprising the customary keys 2, a display 3 and a microphone 4 in a housing 5. In this example, the display is a liquid crystal display device with a layer of liquid crystal material (not shown) between two substrates 6, 7. The display 3 may be of the active (AMLCD) or the passive type.

The display 3 is fixed in this example on a transparent support (substrate) 8 having recesses 9 at the area of the keys 2.

The substrate 8 (the support) is made of, for example, a synthetic material and, according to the invention (see FIG. 3), it comprises an optical waveguide with a substrate of an optically transparent material, and at least one light source along a part of the edge of the optical waveguide, as well as a photosensitive element. By way of illustrating the invention, the part 10 of the substrate 8 within the rectangle ABCD is considered to be the optical waveguide in FIG. 3. A light source 12, 13 which, in this example, consists of, for example, a LED 12 and an optical waveguide 13, is situated along the edge AD of this optical waveguide (the part) 10. A similar light source 12′, 13′ is situated along the edge AB of this optical waveguide 10.

The optical waveguide 10 is constructed in such a way, for example, provided with projecting parts, that light is substantially exclusively coupled in at the area of tracks 20 in one direction and tracks 21 in another direction (in this example, the directions of the light paths are mutually perpendicular). A recess 9 as described with reference to FIGS. 1, 2 is situated at the area of a crossing 24 of both light paths.

A photosensitive element 17, 18 which, in this example, consists of, for example, a photodiode 18 and an optical waveguide 17 is situated along the edge BC of the optical waveguide 10. A similar photosensitive element 17′, 18′ is situated along the edge CD of this optical waveguide 10. In order that light from the optical waveguide 17 is coupled in satisfactorily, (one of) the two optical waveguides may be provided with projecting parts.

When a key 2 is depressed, the light is entirely or partly reflected in the associated light paths 20, 21. Since, in this example, the optical waveguides 13, 13′ are illuminated from one side by the LEDs 12, 12′, the intensity of the light which is coupled in decreases with the distance of the light paths 20, 21 from the LEDs 12, 12′. The current decrease to be recorded is then also dependent on the distance from the LEDs 12, 12′ when the keys are depressed.

Detection circuits coupled to the photodiodes 18, 18′ detect the associated current decrease for both the light paths 20 and the light paths 21 (XY scanning) so that the location of depressing can be determined. For a satisfactory reflection of the keys, these keys are preferably coated with a layer of weakly reflecting material.

The variation of exiting light is detected by means of the photosensitive element, in this example the photodiodes 18, 18′. The light may also be detected at other locations after it has been guided from the optical waveguide (the part) 10 to a suitable location by means of mirrors or other optical elements. If the display device is formed with amorphous (or polycrystalline) TFT transistors in a matrix configuration, the matrix can be extended by extra TFT transistors which are specially arranged for detection and, if necessary, optimized for this purpose. This notably applies when the substrate 6 is omitted and the substrate 8 is also used as an LCD substrate.

For detection of the variation generated by variation of exiting light in the photocurrent of the photodiode, there are various possibilities such as amplification by means of a suitable amplifier. The LEDs 12, 12′ may alternatively emit light pulse-wise.

The decrease of intensity with the distance of the light paths 20, 21 from the LEDs 12, 12′ may be obtained, for example, by decreasing the thickness of the optical waveguides, as is shown in FIG. 4. A light beam 25 emitted by the LED 12 is perpendicularly deflected (light beam 25) to the optical waveguide 10 (ABCD) due to the chamfer of the optical waveguide 13 and impinges upon the reflecting key 2 whose sides extend at an angle of 90 degrees to the direction of the light beam 25′. The light beam 25″ reflected by the key reaches the photodiode 18′ (light beam 25′″) via the optical waveguide 17′. To enhance the reliability of the measurement, the intensity of the on-going beam (light beams 25^{iv}, 25^{v}) can simultaneously be determined via the optical waveguide 17 and the photodiode 18. Similarly, scanning takes place in the other direction by means of the LED 12, the optical waveguides 13′, 17 and the photodiode 18 (and, if necessary, the photodiode 18). Instead of decreasing the intensity, the frequency of the light which has been coupled in may be decreased or increased by arranging a color filter 30 between the optical waveguides 13, 13′ and the optical waveguide 10, which color filter varies in color from (infra)red to (ultra)violet. The light measurement can then take place through frequency measurement.

If desired, a common LED 12 may be used for the optical waveguides 13, 13′ and a common photodiode 18 may be used for the optical waveguides 17, 17′ (see FIG. 4a).

FIG. 6 shows some possibilities of decreasing the intensity of the optical waveguides. For example, use may be made of a set of (parallel) grooves 25 in a surface 27 whose depth and width increase with an increasing distance from an end face (FIG. 6a). Alternatively, the surface 27 may be parabolic (FIG. 6b).

FIG. 5 shows how light from a LED 12 is guided towards a membrane 11 and a waveguide 13 via separate light paths 16′ and 16″. For example, the light from the waveguide 13 is coupled out towards a light detector 18. The intensity of the light reaching the light detector is determined again by the presence of keys 2 in the apertures 9. For the sake of clarity, the light paths are only shown for one direction. FIG. 4 thus shows the possibility of complete integration of a keyboard, a microphone (the membrane 11 in combination with the LED 12 and a photodiode which is not shown) and an LCD (or another display device) in one substrate.

The invention is of course not limited to the embodiments shown. For example, light sources other than LEDs may be used. Instead of a liquid crystal display device, other display devices may be used alternatively such as those that are based on electrophoresis, electroluminescence, P(O)LEDs and, for example, mechanical mirrors. Moreover, the sensor is applicable in completely different fields, for example, in data entry devices having, for example, a memory function (for example, semiconductor memories or a recording function for writable ROMs) or in electronic typewriters.

The protective scope of the invention is not limited to the embodiments described hereinbefore.

The invention resides in each and every novel characteristic feature and each and every combination of characteristic features. Reference numerals in the claims do not limit their protective scope. Use of the verb “comprise” and its conjugations does not exclude the presence of elements other than those stated in the claims. Use of the article “a” or “an” preceding an element does not exclude the presence of a plurality of such elements.

1. A sensor comprising a first optical waveguide of an optically transparent material and at least one light source along a part of the edge of the optical waveguide, and a photosensitive element, wherein, during operation, keys interrupt the light path of the light from the light source.

2. A sensor as claimed in claim 1, comprising two light sources along different parts of the edge of the first optical waveguide and associated photosensitive elements, wherein the light beams from different light sources, viewed transversely to a surface of the optical waveguide, extend at an angle to each other.

3. A sensor as claimed in claim 1 or 2, wherein the light source comprises a second optical waveguide and wherein light can be coupled into the first optical waveguide from the second optical waveguide at different locations along the part of the edge of the first optical waveguide.

4. A sensor as claimed in claim 1 or 2, wherein the photosensitive element comprises a third optical waveguide and wherein light can be coupled into the third optical waveguide from the first optical waveguide at different locations.

5. A sensor as claimed in claim 1 or 2, wherein the photosensitive element is situated along a further part of the edge of the optical waveguide.

6. A sensor as claimed in claim 1 or 2, comprising an optical waveguide having a plurality of end faces, at least one of which is an entrance face for light, while light from the light source can be coupled in on said end face of the optical waveguide.

7. A sensor as claimed in claim 6, wherein the photosensitive element is situated at the area of a further end face opposite the end face of the optical waveguide.

8. A sensor as claimed in claim 6, wherein the quantity of light which can be coupled in per surface unit of the end face varies in intensity or wavelength.

9. A sensor as claimed in claim 8, wherein, during use, the quantity of light which can be coupled in per surface unit of the end face decreases in the direction of the end face.

10. A sensor as claimed in claim 1 or 2, wherein the substrate has recesses at the area of keys.

11. A sensor as claimed in claim 10, wherein keys in recesses of the substrate are light-reflecting at least along a part of their surface.

12. A display device comprising an illumination element having at least one pixel and a further optical waveguide for illuminating the pixel, and a device as claimed in claim 1 or 2.

13. A display device as claimed in claim 12, wherein the optical waveguide and the further waveguide belong to one substrate.

14. A data entry device having at least a memory function and comprising a sensor as claimed in claim 1 or 2.
